(19) United States
(12) Patent Application Publication
(10) Pub. No.: US 2005/0002311 A1
(43) Pub. Date: Jan. 6, 2005

(54) Hologram recording medium and method of hologram recording and reproduction

(76) Inventors: Katsutaro Ichihara, Yokohama-shi (JP); Urara Ichihara, Yokohama-shi (JP); Akiko Hirao, Chiba-shi (JP); Kazuki Matsumoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/835,614

(22) Filed: Apr. 30, 2004

(30) Foreign Application Priority Data
May 9, 2003 (JP) 2003-131611

(51) Int. Cl. G11B 7/00

(52) U.S. Cl. 369/103; 369/109.01; 369/44.11

(57) ABSTRACT

A hologram recording medium has a transparent substrate having an incidence surface, on which a write beam and a reference beam are made incident, and a servo surface opposite to the incidence surface, the servo surface including a header section and a data section, a reflecting layer formed on the servo surface of the transparent substrate, and a hologram recording layer provided on the incidence surface of the transparent substrate, the servo surface having intermittent tracking grooves in the data section except for recording positions, and a width of the tracking grooves being set at a value to less than an e⁻² diameter of the reference beam.

### CROSS-REFERENCE TO RELATED APPLICATIONS

This application is based upon and claims the benefit of priority from prior Japanese Patent Application No. 2003-131611, filed May 9, 2003, the entire contents of which are incorporated herein by reference.

### BACKGROUND OF THE INVENTION

1. Field of the Invention

The present invention relates to a hologram recording medium and a method of hologram recording and reproduction.

2. Description of the Related Art

Systems of an optical recording medium and an optical recording device for applying a light beam to reproduce information or record and reproduce information have the advantages of medium compatibility and a long archival life in comparison with hard disks, and have the advantage of high-speed access in comparison with tapes. Therefore, the systems have become widespread in many fields such as storage devices for computer backup, home-use storage devices for video reproduction or video recording and reproduction, in-vehicle navigators, storage devices for camcorders or personal digital assistance devices, and storage devices for professional use such as medical, broadcast or movie use.

In order to make optical storage devices more wide use and extend their application areas, further improvements of storage capacities and data transfer speeds are required. Up to now, mainstream optical storage devices are optical disks, because the fast access and ease-of-use peculiar to the form of disk are preferred.

Optical disks widely spread include read-only CD-ROMs and DVD-ROMs, recordable WORMs, CD-Rs, and DVD-Rs, rewritable CD-RWs, DVD-RAMs, DVD±RWs, and MOs. In all of these optical disks, a light beam is narrowed to the vicinity of the diffraction limit by an objective lens and applied to the recording surface of the medium with the focus on it to reproduce or record and reproduce information. For this reason, it can be said that reducing the wavelength of the light or increasing the numerical aperture of the objective lens is, in principle, the only way to increase the storage capacity. This is because all techniques proposed in order to improve the storage capacity, including mark-edge recording, land/groove recording, modulation-demodulation techniques represented by PRML, single-sided multi-layer recording techniques in which recording layers are disposed in different focal depths, and super-resolution reproduction techniques, use a method of obtaining focus on the recording surface, and thus, reduction in the wavelength of the light source and increase of the numerical aperture of the objective lens substantially increases the storage capacity.

Hologram recording has been proposed as an optical recording technique using a principle absolutely different from those for conventional optical disks described above. In hologram recording, a beam narrowed to the diffraction limit is not applied to a recording medium. In hologram recording, a recording medium having thickness of the order of thousand times of a conventional optical disk is used, and data is three-dimensionally recorded in the medium including the thickness direction. At that time, information is recorded every frame or page at once using a liquid crystal shutter or a digital mirror array. The recording principle is that a write beam (plane wave or spherical wave modulated with data) and a reference beam (plane wave or spherical wave not modulated with data) are applied simultaneously to a medium to generate chemical change in the section where the light intensities are enhanced by interference between the write beam and the reference beam. The chemical change is three-dimensionally recorded in the medium as an interference pattern corresponding to the data signals. In addition, different interference patterns may be recorded by angular multiplexing or shift multiplexing in the same place or in places overlapping each other of the hologram recording layer. Reproduction is performed every frame or page at once by irradiating the medium with the reference beam and utilizing scattered light or transmitted light according to the interference pattern recorded in the medium. In a case of recording by angular multiplexing, different multiple interference patterns can be reproduced by applying the reference beam to the same place of the medium while varying the angle. In a case of recording by shift multiplexing, interference patterns overlapping each other can be reproduced by applying the reference beam to the medium while shifting the reference beam in the order of about 10 μm.

In such a manner, the hologram recording system can record and reproduce data every frame or page at once by one light application and can record different information in and reproduce the different information from the same place or different places overlapping each other of the medium, and thereby can be expected to significantly increase the storage capacity and the transfer speed in comparison with a conventional optical recording system according to bit-by-bit recording (system of recording or reproducing only one bit by one light application).

Many proposals have been made for hologram recording, and most of them adopt a transmission-type angular-multiplexing recording technique (see, for example, Japanese Laid-open Patent Publication No. 2002-40908). In this technique, different interference patterns are recorded in the same place while varying the relative incident angle between the write beam and the reference beam when recording the interference patterns by applying simultaneously the write beam and the reference beam to the hologram recording layer having the thickness of the order of hundreds of μm. Reproduction is performed by applying the reference beam, while varying the angle of the reference beam, to the positions where the interference patterns have been recorded and by detecting the transmitted light from the medium. The transmission-type angular-multiplexing technique has the advantage of easily obtaining a significant high storage capacity. On the other hand, this technique has the disadvantages of a narrow margin for angle deviation and a narrow margin for the accuracy of alignment of the incidence optical system and the transmission reproducing optical system, leading difficulty to reduce the size and cost of the system.

In recent years, reflection-type collinear recording/reproducing techniques have been proposed for the purpose of solving the problems of the transmission-type angular-multiplexing recording technique described above (see, for example, Japanese Laid-open Patent Publication Nos. 11-311937, 2002-123949, 2002-123948, and 2002-183975). These techniques use a medium comprising a reflecting layer formed on a surface opposite to the incidence surface of the transparent substrate and a hologram recording layer formed on the incidence surface of the transparent substrate. A write beam and a reference beam are collinear applied to the hologram recording layer of the medium so as to bring a focal position onto the reflection surface, and the incident reference beam or write beam is made interfere with the write beam or reference beam reflected by the reflection surface to record interference patterns. The techniques described in the references cited above will be explained more specifically. Linearly polarized light beams having polarization planes perpendicularly crossing to each other are used as a write beam and a reference beam. An objective lens is provided in the closest vicinity of the incidence surface of the medium. At the incidence side of this objective lens, a gyrator gyrating the polarization plane either at +45° or at −45° (two-channel gyrator) is provided. The polarization planes of the write beam and reference beam intersect at right angles before the incidence on the gyrator. The write beam is gyrated at +45° (or −45°) by means of a half of the gyrator and the reference beam is gyrated at −45° (or +45°) by means of the other half of the gyrator. Thus, the polarization planes of the write beam and reference beam match with each other. When the two beams are made incident on the medium through the objective lens, the write beam and the reference beam interfere with each other in the hologram recording layer, and an interference pattern corresponding to the information carried by the write beam is formed. Reproduction is performed by applying the reference beam to the medium and reading the recorded interference pattern in a reflection manner like recording. Since the polarization planes of the write beam and reference beam intersect at right angles before the incidence on the gyrator, the beams do not interfere with each other in the incidence optical system. Because of this, a fine interference pattern is recorded in the hologram recording layer and can be surely reproduced from it.

In the reflection-type collinear recording/reproducing technique, shift multiplexing is used. For example, when the length of one data section is hundreds of μm (this length depends on the thickness of the substrate or the thickness of the recording layer), different interference patterns are recorded and reproduced by shifting the beams in the order of 10 μm. Like angle multiplexing, a plurality of interference patterns may be physically formed in the same place independently and reproduced independently. In this reflection-type collinear recording/reproducing technique, only one unit of optical system is provided in which the incidence optical system and the detection optical system may have the same constitution, leading to the advantage of not having the problem of alignment of the optical systems as in the transmission-type. In addition, the technique has the advantage of having a wide margin for shift amount and having an excellent compatibility with current DVDs and CDs because it performs recording and reproduction by concentric wave front around a focal position as the center.

By the way, the hologram recording medium of a conventional reflection-type collinear shift multiplexing use sample servo, because if a tracking guide groove is provided to implement continuous servo, the write beam or reference beam are irregularly reflected by the tracking guide groove, so that desired recording becomes impossible. However, the sample servo has basic problems of being inferior in servo stability, easily generating a track count error in seek operation, and having a low format efficiency. Furthermore, when the compatibility with current recordable DVDs and CDs adopting the continuous servo is taken into consideration, the reflection-type collinear hologram recording medium using the sample servo has a disadvantage of inferior compatibility. This is a very serious problem in development of the hologram recording medium as a consumer product

### BRIEF SUMMARY OF THE INVENTION

An object of the present invention is to provide a hologram recording medium and a method of hologram recording and reproduction to which continuous tracking servo, that brings about a good stability of tracking and track count in seek operation, a high format efficiency, and an excellent compatibility with DVDs and CDs, is applicable without impairing good hologram recording/reproducing characteristics.

A hologram recording medium according to a first aspect of the present invention comprises: a transparent substrate having an incidence surface, on which a servo beam, a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having a continuous tracking groove in the data section, and a width of the tracking groove being set at a value less than an e⁻² diameter of the servo beam and at a value equal to or more than an e⁻² diameter of the write beam and reference beam.

A hologram recording medium according to a second aspect of the present invention comprises: a transparent substrate having an incidence surface, on which a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having a continuous tracking groove in the data section, and a width of the tracking groove being set at a value equal to or more than an e⁻² diameter of the write beam and reference beam at recording positions and less than an e⁻² diameter of the reference beam at non-recording positions.

A hologram recording medium according to a third aspect of the present invention comprises: a transparent substrate having an incidence surface, on which a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having intermittent tracking grooves in the data section except for recording positions, and a width of the tracking grooves being set at a value less than an e⁻² diameter of the reference beam.

A hologram recording medium according to a fourth aspect of the present invention comprises: a transparent substrate having an incidence surface, on which a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having a continuous tracking groove in the data section, a depth of the tracking groove being set at an extinction condition, and a width of the tracking groove being set at a value between 20% and 40% of an e⁻² diameter of the write beam and reference beam.

A method of hologram recording and reproduction for the hologram recording medium according to the first aspect of the present invention comprises: performing tracking servo by applying the servo beam to the servo surface while adjusting the focal position to the servo surface and by utilizing the reflected servo beam; performing recording to the hologram recording layer by applying simultaneously both of the write beam carrying data to be recorded and reference beam, whose polarization planes are matched with each other, to the recording positions while adjusting the focal positions to the servo surface; and performing reproduction from the hologram recording layer by applying the reference beam to the recording positions while adjusting the focal position to the servo surface.

A method of hologram recording and reproduction for any one of the hologram recording medium according to the second to fourth aspect of the present invention comprises: performing tracking servo by applying the reference beam while adjusting the focal position to the servo surface and by utilizing the reflected reference beam; performing recording to the hologram recording layer by applying simultaneously both of the write beam carrying data to be recorded and reference beam, whose polarization planes are matched with each other, to the recording positions while adjusting the focal positions to the servo surface; and performing reproduction from the hologram recording layer by applying the reference beam to the recording positions while adjusting the focal position to the servo surface.

### BRIEF DESCRIPTION OF THE SEVERAL VIEWS OF THE DRAWING

FIG. 1 is a schematic view showing the recording principle for a reflection-type collinear hologram recording medium according to the embodiments of the present invention;

FIG. 2 is a schematic view showing the reproduction principle for a reflection-type collinear hologram recording medium according to the embodiments of the present invention;

FIG. 3 is a view showing the basic configuration of a hologram recording/reproducing optical system according to the embodiments of the present invention;

FIG. 4 is a cross-sectional view showing an example of a hologram recording medium according to the embodiments of the present invention;

FIG. 5 is a plan view showing an example of structure of a servo surface of a conventional hologram recording medium;

FIG. 6 is a plan view showing the basic structure of a servo surface of a hologram recording medium according to the embodiments of the present invention;

FIG. 7 is a plan view showing the structure of a servo surface of a hologram recording medium according to the first embodiment of the present invention;

FIG. 8 is a plan view showing the structure of a servo surface of a hologram recording medium according to the second embodiment of the present invention;

FIG. 9 is a plan view showing the structure of a servo surface of a hologram recording medium according to the third embodiment of the present invention;

FIG. 10 is a plan view showing the structure of a servo surface of a hologram recording medium according to the fourth embodiment of the present invention;

FIG. 11 is a schematic view showing an example of system configuration of a hologram recording/reproducing device according to the embodiments of the present invention.

### DETAILED DESCRIPTION OF THE INVENTION

A hologram recording medium and a method of hologram recording and reproduction according to embodiments of the present invention are described in detail below with reference to the drawings.

(Recording Principle)

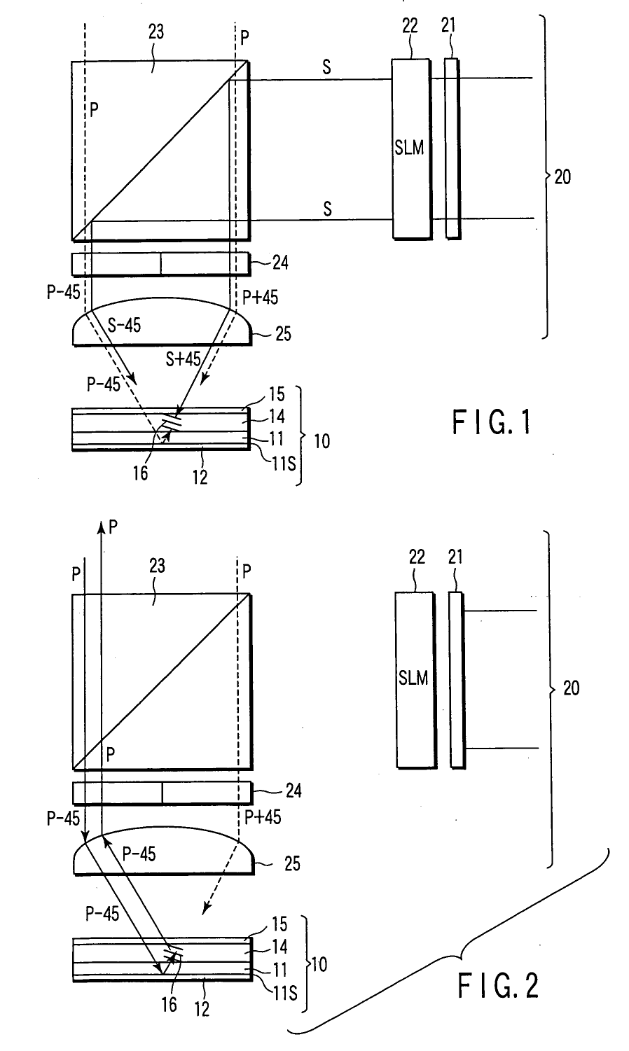

FIG. 1 is a schematic view showing the recording principle for a hologram recording medium of a reflection-type collinear shift multiplexing in an embodiment of the present invention. This drawing shows the hologram recording medium 10 and a part of the recording/reproducing optical system 20. The hologram recording medium 10 shown in FIG. 1 is so structured that a reflecting layer 12 is formed on the lower surface of the transparent substrate 11 and a hologram recording layer 14 and protection layer 15 are formed on the upper surface of the transparent substrate 11. As shown in this drawing, the upper surface of the transparent substrate 11 is an incidence surface, and the lower surface opposite to the incidence surface is used as a servo surface 11s. In the hologram recording medium according to the embodiments of the present invention, as described in detail later, a header section and a data section are defined on the servo surface, and a tracking guide groove is formed on the data section.

In FIG. 1, the solid lines (s-polarized light in this drawing) indicate a write beam, and the dotted lines (p-polarized light) indicate a reference beam. The reason that the write beam and the reference beam are indicated with different kinds of lines is for the sake of easy understanding. Actually the write beam and the reference beam are both light beams having the same wavelength emitted from the same light source.

In the incident side for the write beam, a shutter 21 and a spatial light modulator (SLM) 22 are provided. A data signal is superposed on the write beam by driving the SLM 22 with the data signal. The s-polarized write beam is made incident on the polarized beam splitter (PBS) and is turned 90° to the hologram recording medium 10, and then passes through the two-channel gyrator 24. In the example shown in FIG. 1, the right side of the two-channel gyrator 24 is set to a +45° gyration, while the left side thereof is set to a −45° gyration. The polarization plane of the s-polarized write beam, which has passed through the right side of the gyrator 24, is gyrated to s+45°, and the polarization plane of the s-polarized write beam, which has passed through the left side of the gyrator 24, is gyrated to s−45°. After that, the s-polarized write beam is focused on the hologram recording medium 10 through the objective lens 25.

On the other hand, the p-polarized reference beam is made incident on the top of the PBS 23 and then travels straight in the PBS 23. The polarization plane of the reference beam, which has passed through the right side of the gyrator 24, is gyrated to p+45°, and the polarization plane of the reference beam, which has passed through the left side of the gyrator 24, is gyrated to p−45°. After that, the reference beam is focused on the hologram recording medium 10 through the objective lens 25.

Here, for example, the write beam having a polarization plane of s+45° and the reference beam having a polarization plane of p−45° match with each other in polarization plane, thus forming an interference pattern 16 corresponding to the data signal into the hologram recording layer 14 as shown in FIG. 1. FIG. 1 shows only an interference pattern formed by the write beam having a polarization plane of s+45° and the reference beam having a polarization plane of p−45°. However, the write beam having a polarization plane of s−45° and the reference beam having a polarization plane of p+45° also match with each other in polarization plane, thus forming an interference pattern corresponding to the data signal into the hologram recording layer 14. In addition, FIG. 1 shows only a case that the incident write beam of s+45° and the reflected reference beam of p−45° interfere with each other at the right side of the hologram recording layer 14, but there also is a case that the reflected write beam of s+45° and the incident reference beam of p−45° interfere with each other at the left side of the hologram recording layer 14. Consequently, a signal of the SLM 22 is doubly recorded in the hologram recording layer 14. Since the total thickness of the hologram recording layer 14 and the substrate 11 is generally set at a value between the order of hundreds of μm and 1 mm, the optical path difference between the write beam and the reference beam is little. Therefore, in the configuration in FIG. 1, the data signal for the upper part of the SLM 22 (be made incident on the right side of the gyrator 24) and the data signal for the lower part of the SLM 22 (be made incident on the left side of the gyrator 24) are doubly recorded in the same place in the right side and the left side of the hologram recording layer 14, respectively. Since the upper part and lower part of the SLM 22 are different in information pattern, the data signals are written doubly. However, the data signal for each the upper part and lower part of the SLM 22 forms the same interference pattern two times in the right side and the left side of the hologram recording layer 14, respectively. Thus, signal quality is not inferior to that of transmission-type angle multiplexing reproduction.

(Reproducing Principle)

FIG. 2 is a schematic view showing the reproduction principle for a hologram recording medium of a reflection-type collinear shift multiplexing in the embodiments of the present invention. This drawing shows the same components as FIG. 1. In reproduction, the shutter 21 in the incident side for the write beam is closed. Since it is enough for the shutter 21 to have a function of preventing the write beam from being made incident on the recording medium 10 in reproduction, a liquid crystal shutter, a s-polarized light reflection plate, a total reflection plate, or the like can be used as the shutter 21. In reproduction, the p-polarized reference beam is used. Here, attention is paid to the reproduction reference beam incident on the left side of the PBS 23. The incident p-polarized beam passes through the left side of the gyrator 24, by which the polarization plane thereof is gyrated to p−45°, and the beam passes through the objective lens 25 and is made incident on the recording medium 10, in which interference patterns 16 are recorded. FIG. 2 shows, in correspondence with FIG. 1, that the reflected reference beam of p−45° is diffracted by an interference pattern 16. In this example, the recorded interference pattern 16 has been formed with the write beam of s+45° and the reference bean of p−45°, and hence when the reproduction reference beam of p−45° is made incident thereon, it is diffracted in accordance with the interference pattern 16 and then returns to the objective lens 25. The diffracted light which has passed through the objective lens 25 passes through the gyrator 24 from the side opposite to that at incidence, thus being gyrated by +45°. As a consequence, the polarization plane of the reference beam goes back to p=p−45°+45°. The reference beam then passes straight in the PBS 23 and is made incident on the reproduction optical system (not shown in FIG. 2).

A part of the reflected reference beam, which has not diffracted by the interference pattern 16 passes straight through the right side of the objective lens 25. Since this beam passes through the right side of the gyrator 24 from the lower side thereof, the polarization plane of this beam becomes s=p−45°−45°, which is unable to go straight in the PBS 23 and turned 90° to the SLM 22. Consequently, this beam does not enter the reproduction optical system and does not absolutely become a noise source.

In addition, a part of the incident reference beam of p−45° is also diffracted, before it is made incident on the reflecting layer 12, by the same interference pattern, which has been written in the left side of the hologram recording layer 14, and contributes to the signal. That is, the reproduced signal is produced by the diffraction of the reflected reference beam shown in FIG. 2 and the diffraction of the incident reference beam, and hence signal quality is improved. The reproduction reference beam (indicated by a dotted line in FIG. 2) made incident on the right side of the PBS 23 works like the reproduction reference beam made incident on the medium 10 in p−45° except that it is made incident on the medium 10 in p+45°.

(Basic Configuration of Recording/Reproducing Optical System)

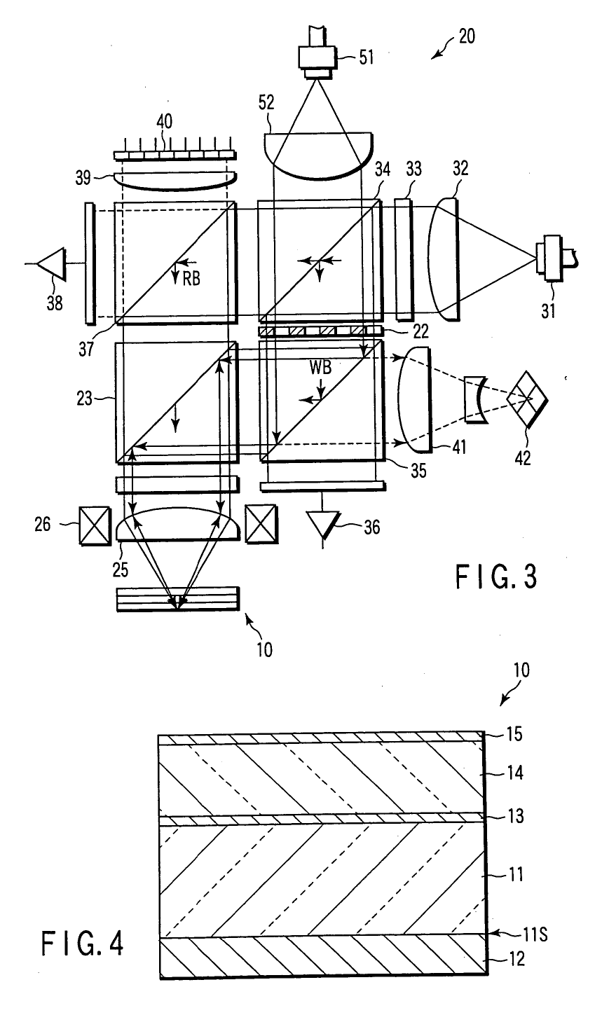

FIG. 3 shows the basic configuration of a hologram recording/reproduction optical system including a servo optical system, in the embodiments of the present invention. FIGS. 1 and 2 already described show a part of the optical system shown in FIG. 3 and the hologram recording medium 10.

The recording/reproducing light source 31 uses a laser-light source having a large coherence length suitable for hologram recording. At present, the common light source used for hologram recording is a solid laser having the wavelength of 532 nm, and a Kr⁺ gas laser or a semiconductor laser with an external resonator (the wavelength thereof may be freely selected from blue to near infrared, typically 405 nm, 650 nm, 780 nm, or the like) may also be used. In addition, it is expected that semiconductor laser diodes such as distributed feedback (DFB) laser, distributed Bragg reflector (DBR) laser, and vertical cavity surface-emitting laser (VCSEL) having a large coherence length without an external resonance described later will be available at low prices and will be able to be used as the recording/reproducing light source 31 in the future.

Light emitted by the recording/reproducing light source 31 is changed into parallel light by the lens 32 for recording/reproducing light source, and then the intensity of the light is adjusted by the λ/2 plate (half-wave plate) 33 for a recording beam and a reference beam. A beam forming prism or the like may be provided between the recording/reproducing light source 31 and the lens 32 for recording/reproducing light source, which depends on a light source to be used. The intensity adjustment can be implemented by rotating the λ/2 plate 33. As described later, it is desirable to make the intensity of the s-polarized write beam coincide with the intensity of the p-polarized reference beam in recording. The write/reference beam pass through the λ/2 plate 33 and then are made incident on the PBS 34 on the light source side and is divided into an s-polarized write beam (light traveling to the lower side of the PBS 34 in FIG. 3) and a p-polarized reference beam (light traveling to the left side of the PBS 34 in FIG. 3).

The write beam passes through the shutter (not shown in FIG. 3) and the SLM 22, and then is made incident on the first half mirror (first HM) 35. A part of the write beam is made incident on the photo detector (write beam PD) 36 by which the intensity thereof is detected. Another part of the write beam the optical path of which has been turned 90° by the first HM 35 is made incident on the PBS 23 on the medium side, by which the optical path is turned 90° again, and then it is made incident on the hologram recording medium 10. In a case that detection of the intensity of the write beam by the write beam PD is not performed, a PBS for totally reflecting s-polarized light may be provided instead of the first HM 35 to increase the efficiency of the write beam.

On the other hand, the p-polarized reference beam straightly passes through the PBS 34 on the light source side, and then is made incident on the second HM 37. A part of the reference beam is made incident on the photo detector (reference beam PD) 38 by which the intensity thereof is detected. Another part of the reference beam the optical path of which has been turned 90° by the second HM 37 passes through the PBS 23 on the medium side, and then is made incident on the hologram recording medium 10.

It is desirable, as described above, that the write beam PD 36 detects the intensity of the write beam, the reference beam PD 38 detects the intensity of the reference beam, and the detected intensities are returned to the λ/2 plate 33 in order to make the intensities of the write beam and the reference beam, which are made incident on hologram recording medium 10, coincide with each other.

After that, recording and reproduction operations are performed according to the recording and reproduction principles as described above in detail with reference to FIGS. 1 and 2. Supplementary description about the reproducing optical system is provided as follows. As described above with reference to FIG. 2, the diffracted light contributing to reproduction returns to p-polarized light. The p-polarized light goes straight in the PBS 23, and further goes straight in the second HM 37. Then the light is converged by the imaging lens 39 (this is not always required), and is made incident on the CCD detector 40. The interference patterns are reproduced at once by means of the CCD detector 40. The reproduced interference patterns are converted to electrical signals to be detected. The second HM 37 directs a part of the reproduced light to the light source 31. However, if a monitor is provided at the front-end or the back-end of the light source 31 as necessary, and the light source is driven by performing high-frequency superposition or the like, the stability of light emitted from the light source can be retained.

As shown in FIG. 3, a servo light source 51 used only for servo may be optionally provided independent of the recording/reproducing light source 31. It is common way to change the wavelengths of the two light sources, more specifically to set the wavelength of the servo light source 51 at a value larger than the wavelength of the recording/reproducing light source 31. For example, when the wavelength of the recording/reproducing light source 31 is 405 nm, the wavelength of the servo light source is set at 532 nm, 650 nm, 780 nm, or the like. Alternatively, when the wavelength of the recording/reproducing light source 31 is 532 nm, the wavelength of the servo light source is set at 650 nm, 780 nm, or the like. In this case, the servo beam passes the light path of the lens 52 for servo light source, the PBS 34 on the light source side, the first HM 35, and the PBS 23 on the medium side, and then is made incident on the hologram recording medium 10. However, the light path of the servo beam may be changed according to design of the PBSs.

In the embodiments of the present invention, the servo beam (or reference beam) is made incident on the hologram recording medium 10, and focusing, tracking, and addressing are performed using the reflected beam from the servo surface. In a case that the reference beam is used instead of the servo beam, it is not necessary to provide the servo light source.

In FIG. 3, the servo beam (or reference beam) reflected by the servo surface of the hologram recording medium 10 is turned 90° by the PBS 23 on the medium side, and then is made incident on and goes straight in the first HM 35. After that, the servo beam passes through the servo lens 41, and then is made incident on the servo detecting system 42 including a four-cell PD for focusing and tracking. In this connection, the servo beam (or reference beam) reflected by the servo surface may be detected through a multistage half mirror to perform focusing, tracking, and addressing independently. For such a servo beam detection system, a configuration basically similar to those of conventional DVDs and CDs may be adopted. Focusing, tracking, and addressing control are performed in such a manner that the detected servo beam (or reference beam) is converted into an electrical signal, the electrical signal is inputted to the controller, and a control signal is sent from the controller to the voice coil motor (VCM) 26 to drive the objective lens 25 mechanically.

(Medium Structure)

FIG. 4 is a cross-sectional view showing an example of basic structure of a hologram recording medium according to the embodiments of the present invention. As shown in FIG. 4, the lower surface (opposite to the incidence surface) of the transparent substrate 11 is a servo surface 11s, on which a reflecting layer 12 is formed. On the upper surface (incidence surface) of the transparent substrate 11, an intermediate layer 13, a hologram recording layer 14, and a protection layer 15 are formed.

As the transparent substrate 11, a transparent material having a thickness between the order of hundreds of μm and 1 mm is generally used. As the substrate material, glass, or transparent resin represented by polycarbonate, polymethyl methacrylate, amorphous polyolefin, etc. may be used.

The thickness of the substrate may be set at a value between the orders of several μm to 100 μm. In this case, transparent thermosetting resin film, UV curing resin film, or the like is preferably used as the substrate material. For example, the substrate is formed in such a manner that after a hologram recording layer is formed by casting or the like, an intermediate layer is formed as necessary, and substrate material is applied thereon.

The thickness of the substrate may also be set at a value between the order of tens of nm and 1 μm. In this case, as the material of the substrate, transparent material such as SiO₂, Si₃N₄, AlN, Al₂O₃, BN, TiO₂, MgF₂, CaF₂, Y₂O₃, ITO, In₂O₃, ZnO, ZrO₂, Nb₂O₅, SnO₂, TeO, DLC, C—H polymer film, or C—F polymer film is preferably used. These films may be formed by such a deposition method as sputtering, evaporation, and plasma polymerization.

As described above, the material of the substrate may be selected from a wide range of materials. However, in consideration of forming the servo surface, it is desirable that glass is used as the substrate, on which a servo pattern consisting of resist is provided by a photopolymer process (PP), or transparent resin represented by polycarbonate is used as the substrate, in which a servo pattern is provided by injection molding.

As the reflecting layer, thin film material totally reflecting light having an operation wavelength is preferably used. Specifically, for a wavelength between 400 nm and 780 nm, Al alloy or Ag alloy is desired, and for the wavelength of 650 nm or more, Au, Cu alloy, TiN or the like may be used in addition to the Al alloy or Ag alloy. The thickness of the reflecting layer is preferably 50 nm or more, more preferably 100 nm or more so as to totally reflect light.

The intermediate layer 13 is not essential, but when resin is used as the substrate 11, a transparent intermediate layer is preferably provided in order to protect mutual diffusion between the resin substrate and the organic hologram recording layer. As the material of the intermediate layer, transparent material such as SiO₂, Si₃N₄, AlN, Al₂O₃, BN, TiO₃, MgF₃, CaF₂, Y₂O₃, ITO, In₂O₃, ZnO, ZrO₂, Nb₂O₅, SnO₂, TeO, DLC, C—H polymer film, or C—F polymer film may be used, and a thermosetting resin film, UV curing resin film, or the like may also be used.

The hologram recording layer 14 is basically formed using organic material. As the write-once-read-many hologram recording layer, a photopolymer, a photo addressable polymer, or the like is preferably used. As the rewritable hologram recording layer, a photo refractive polymer is preferably used. A typical film thickness of the hologram recording layer 14 is the order of hundreds of μm as described above, and may be set at a value within the wide range from tens of μm to several mm according to a desired storage capacity and a data transfer speed. For example, the photopolymer includes monomer, initiator (photo-polymerization initiator, photo charge generator, or the like), and matrix (polymer, oligomer, or the like) as basic components. By applying simultaneously the write beam and the reference beam to the hologram recording layer 14, the initiator functions in the matrix, and the monomer photo-polymerizes to produce a refractive index distribution corresponding to the interference pattern. As a result of this, hologram recording is performed.

The protection layer 15 is not essential, but is preferably provided to protect the hologram recording layer 14 mechanically. The protection layer may be bulk glass or transparent resin material, or may be transparent thin film material similar to those for the intermediate layer 13 described above. Furthermore, it is desirable to use film having a high sensitive photo-bleaching function or film having a photochromic function as the protection layer because the deterioration of the hologram recording layer caused by natural light is prevented and the shelf life is improved. Since the recording layer before recording is in a quasi-stable state that the monomer is distributed, there is a problem on the deterioration caused by natural light. However, since the recording layer after recording is in a stable state that the polymerization of the monomer has completed according to the interference pattern, there is no problem on the archival-life without a protection layer.

Various methods may be used to produce the hologram recording medium according to the embodiments of the present invention as shown in FIG. 4. The methods include (1) a method of forming the hologram recording layer 14 and the protection layer 15 as necessary on the substrate 11, on which the reflecting layer 12 has been provided, directly or via the intermediate layer 13, (2) a method of forming the reflecting layer 12 after forming the hologram recording layer 14 and the protection layer 15 as necessary on the substrate 11 directly or via the intermediate layer 13, and (3) a method of forming the reflecting layer 12 and the intermediate layer 13 as necessary, while separately forming the hologram recording layer 14 and the protection layer 15 as necessary by casting, and subsequently bonding the hologram recording layer 14 onto the substrate 11 or the intermediate layer 13 with transparent resin or the like.

(Structure of Servo Surface)

The structure of the servo surface is important in the hologram recording medium according to the embodiments of the present invention. The servo surface 11s is formed on the lower surface (opposite to the incident surface) of the transparent substrate 11. The servo beam (or reference beam) is focused on the servo surface, and focusing servo, tracking servo and addressing servo are performed based on the reflected beam.

In the following description, at first a servo surface of a conventional hologram recording medium is explained, and subsequently, in contrast to this, the servo surface of the hologram recording medium according to the embodiments of the present invention is explained.

Structure of a Servo Surface of a Conventional Hologram Recording Medium

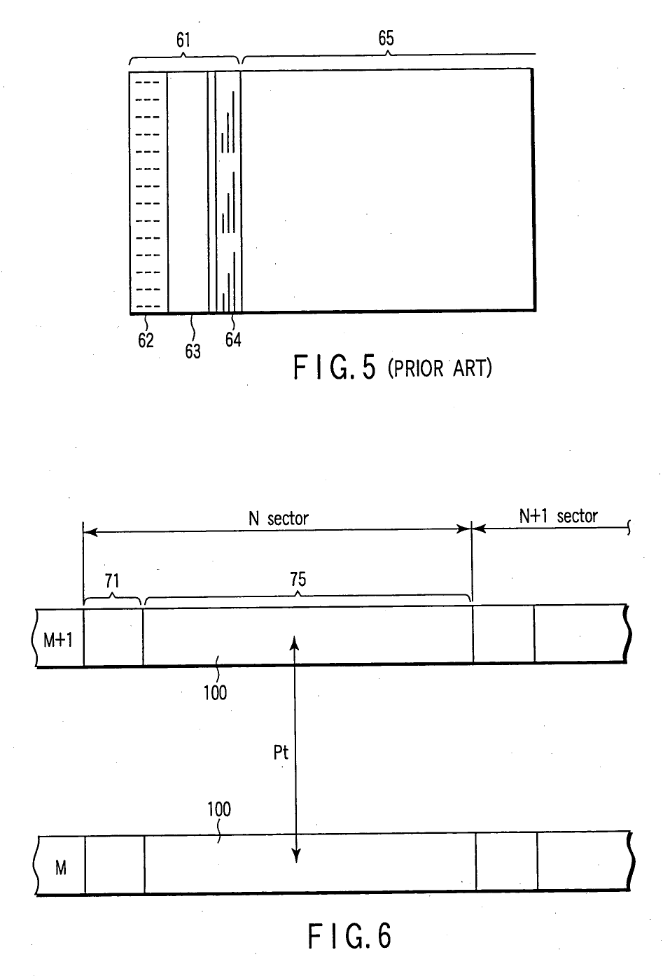

FIG. 5 is a plan view showing an example of structure of a servo surface of a conventional hologram recording medium. This drawing shows the servo surface viewed from the incidence surface of the transparent substrate. As describe later, when a disk-shaped hologram recording medium is used, the servo surface is generally divided into tracks in the disk radial direction and divided into sectors in the tangential direction. As shown in FIG. 5, header sections 61 and data sections 65 are formed alternately along a track direction. Each of the header sections 61 includes a tracking pit train 62, a sector mark 63 consisting of a mirror surface, and an address pit pattern 64 carrying address information and control information. Each of the data sections 65 where user data is recorded is of a mirror surface.

That is, in the conventional hologram recording medium, tracking is performed by sample servo. The most reason of this is that it has been said that if tracking grooves are provided in the data sections 65, the write beam and the reference beam are scattered by irregularity of the data sections and thereby recording and reproduction of a desired interference pattern becomes difficult. However, as described above, sample servo is a technique which provides inferior tracking stability, is apt to cause a track count error in seek operation, provides a low format efficiency, and is hard to provide compatibility with current CDs and DVDs.

Structure of the Servo Surface of the Hologram Recording Medium According to the Embodiments of the Present Invention

The structure of the servo surface of the hologram recording medium using a reflection-type collinear shift multiplexing according to the embodiments of the present invention will be described below. The hologram recording medium according to the embodiments of the present invention allows continuous servo, and is able to solve all the problems on the sample servo used in conventional hologram recording mediums.

Servo methods according to the embodiments of the present invention are classified into the following three methods:

[A] A method of performing continuous servo by utilizing the difference between the spot size of the writing/reference beam and that of servo beam on the servo surface (in the focal position);

[B] A method of performing continuous servo by using the writing/reference beam as the servo beam and applying the reference beam to the positions other than the write positions while identifying the shift multiplexing write positions with the continuous servo pattern; and

[C] A method of performing continuous servo through the tracking groove with narrowed width, by using the writing/reference beam as the servo beam, with the depth of the tracking grooves set at an extinction condition, while performing recording and reproduction by using mirror reflection light from both sides of the grooves.

With reference to FIG. 6, the basic structure of the servo surface of the hologram recording medium according to the embodiments of the present invention will be described. FIG. 6 shows two tracks defined by two tracking grooves 100 aligned in the radial direction. For example, it is assumed that when the lower part of this drawing is the inside of the disk, the lower track is the Mth track, and the upper track is the (M+1)th track. The grooves may be spiral grooves or concentric grooves, and are preferably spiral grooves in consideration of the compatibility with current CDs and DVDs. Track pith Pₜ in the radial direction is set at a value nearly equal to the shift amount. The shift amount is the order of 10 μm as described above, which is larger than those of current CDs and DVDs, and hence it is easy to master the medium.

In the embodiments of the present invention shown in FIG. 6, substantially continuous grooves 100 are provided in the data sections 75 in contrast to the conventional technique shown in FIG. 5. The term “substantially” means that the grooves may not be perfectly continuous in the data sections 75, which may include areas without a groove at midpoints in the data sections 75. In the embodiment of the present invention shown in FIG. 6, each of the header sections 71 may have an address bit pattern carrying address information and control information and does not need a tracking-pit train like the conventional technique shown in FIG. 5, thus providing a high format efficiency correspondingly. In conventional sample servo, off-track easily occurs when the data length is long. However, in the present invention, it is possible to maintain tracking even when the data length is long. Also judging from this point, the present invention provides a formatting efficiency significantly higher than the conventional technique. In addition, the conventional sample servo causes a track count error when the servo beam in seek operation does not intersect the pit train of a header section. In contrast, in the embodiments of the present invention, track count can be performed when the servo beam (or reference beam) intersects either of the header sections and the data sections. The sector structure according to the embodiments of the present invention is similar to those of current CD-ROMs, CD-Rs, CD-RWs, CD-RAMs, DVD-ROMs, DVD-Rs, DVD-RWs, and DVD-RAMs, thus being easy to be compatible with them.

Each of the methods roughly described above will be explained in more detail.

### EMBODIMENT 1

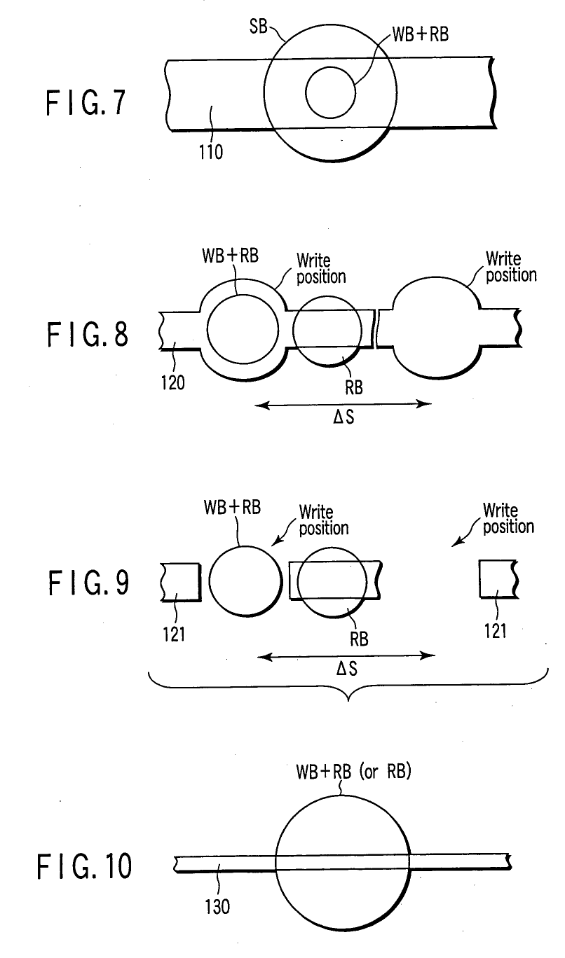

FIG. 7 shows the structure of the servo surface of a hologram recording medium according to the first embodiment of the present invention. In the first embodiment, the width of the tracking groove 110 is set at a value smaller than e⁻² diameter of the servo beam and larger than e⁻² diameter of the write/reference beam. For example, when a laser diode with a external resonator having the wavelength of 405 nm is used as the recording/reproducing light source, a laser diode having the wavelength of 780 nm is used as the servo light source, and an objective lens having the numerical aperture (NA) of 0.45 is used, e⁻² diameter on the servo surface is about 750 nm for the write/reference beam having the wavelength of 405 nm and is about 1440 nm for the servo beam having the wavelength of 780 nm. Here, e⁻² diameter of Gaussian spot on a focal position is a so-called spot size. However, when irregular reflection from the region outside the e⁻² diameter of the write/reproducing beam is also considered, an effective diameter substituting for the e⁻² diameter (spot size) is preferably about 1.2 times larger than the e⁻² diameter (about 890 nm), more preferably about 1.5 times larger than e⁻² diameter (about 1120 nm). In addition, in order to obtain a good tracking characteristic, the grove width is set at a value between the order of 20% and 80% of the e⁻² diameter of the servo beam, preferably between 30% and 80%. In this embodiment, the groove width is set at a value between about 290 nm and 1150 nm, preferably between about 430 nm and 1150 nm. Hence, when the common set of both cases is selected, the tracking groove width is preferably set at a value between about 750 nm and 1150 nm, more preferably between 890 nm and 1150 nm, further preferably between 1120 nm and 1150 nm.

As described above, when the relations between the width of the tracking groove 110, and the e⁻² diameter of the servo beam and the e⁻² diameter of the write/reference beam are set as shown in FIG. 7, the write/reference beam is substantially mirror-reflected on the surface of the tracking groove, and thereby a desired interference pattern can be recorded in the hologram recording layer without irregular reflection, and steady continuous tracking servo can be performed with the servo beam.

### EMBODIMENT 2

FIG. 8 shows the structure of the servo surface of a hologram recording medium according to the second embodiment of the present invention. In the second embodiment, the width of the tracking groove 120 is adjusted to a value equal to or more than the e⁻² diameter of the write/reference beam in positions D where data is written (write positions), and is adjusted to a value less than the e⁻² diameter of the reference beam in positions T where data is not written (non-recording positions). However, when irregular reflection from the region outside the e⁻² diameter of the write/reproducing beam is also considered, an effective diameter substituting for the e⁻² diameter is preferable about 1.2 times larger than the e⁻² diameter (about 890 nm), more preferable about 1.5 times larger than the e⁻² diameter (about 1120 nm). For example, when a laser diode with a external resonator having the wavelength of 405 nm is used as the recording/reproducing light source, and a objective lens having the numerical aperture (NA) of 0.45 is used, the width of the tracking groove in the write positions is set at about 750 nm or more, preferably 890 nm or more, more preferably 1120 nm or more. On the other hand, in the non-recording positions (other than above write positions), the tracking grove width is set at a value between the order of 20% and 80% of the e⁻² diameter of the servo beam, preferably between 30% and 80%. In this embodiment, the tracking groove width is set at a value between about 150 nm and 600 nm, preferably between about 220 nm and 600 nm.

As described above, when the relations between the widths of the tracking groove in the write positions and the non-recording positions other than the write positions, and the e⁻² diameter of the write/reference beam are set as shown in FIG. 8, the write/reference beam is substantially mirror-reflected on the surface of the tracking groove, and thereby a desired interference pattern can be recorded in the hologram recording layer without irregular reflection, and steady continuous tracking servo can be performed with the reference beam in the positions other than the write positions. In this embodiment, writing positions can be identified with the continuous tracking groove itself, and therefore there is an advantage that writing positions can be identified while performing servo operation.

### EMBODIMENT 3

FIG. 9 shows the structure of the servo surface of a hologram recording medium according to the third embodiment of the present invention. The third embodiment corresponds to improvement for the second embodiment. In the third embodiment, intermittent tracking grooves 121 are formed on non-recording positions in the data section except for recording positions, and a width of the tracking grooves 121 are set at a value less than an e⁻² diameter of the reference beam. A desirable width of tracking grooves 121 is as described in the second embodiment.

In the third embodiment, the same effect as described in the second embodiment is obtained. In addition, the third embodiment is simpler in the groove configuration than the second embodiment, bringing an advantage of facilitating mastering of the medium.

### EMBODIMENT 4

FIG. 10 shows the structure of the servo surface of a hologram recording medium according to the fourth embodiment of the present invention. In the fourth embodiment, the depth of the tracking groove 130 is substantially set at λ/4n which is an extinction condition, where λ is the wavelength of the write beam and reference beam and n is the refractive index of the substrate.

By setting the depth of the tracking groove 130 at an extinction condition like this, reflected light does not come from the tracking groove 130 and a desired interference pattern can be formed in the hologram recording layer with reflected light from the mirror surfaces of both sides of the tracking groove 130. In addition, it is possible to perform continuous servo with the reference beam. In this case, the width (lower limit) of the tracking groove is set at 20% of or more than the e⁻² diameter of the reference beam in order to obtain a sufficient tracking signal. In this embodiment, since mirror-reflected light from both sides of the groove is used to form an interference pattern, the narrower the width of the tracking groove 130, the better for the formation of the interference pattern. However, it has been found by experiments of the present inventors that the width of the tracking groove up to the order of 40% of the e⁻² of the reference beam may be allowed. For example, when the wavelength of the write/reference beam is set at 405 nm and the NA of the objective lens is set at 0.45, the width of the tracking groove 130 is set at a value between about 150 nm and 300 nm. Write/reproducing positions are still identified because the shift multiplexing is applied in the embodiment. However, this embodiment is also simpler in the groove configuration than the second embodiment, bringing an advantage of facilitating mastering of the medium.

As described above, when the depth of the tracking groove is set at an extinction condition and the width of the tracking groove is set at a value between 20% and 40% of the e⁻² of the write/reference beam, the write/reference beam is substantially mirror-reflected on the mirror surface of both sides of the tracking groove 130 at write positions, and thereby a desired interference pattern can be recorded in the hologram recording layer without irregular reflection, and steady continuous tracking servo can be performed with the reference beam in the non-recording positions other than the write positions.

### EXAMPLES

Examples of the present invention are described below with reference to the drawings.

### Example 1

In this example, the hologram recording medium according to the embodiment [1] is explained in contrast with a comparative example.

The hologram recording medium having a stacked structure shown in FIG. 4 is manufactured as follows. A polycarbonate disk substrate 11 having a diameter of 120 mm and a thickness of 0.6 mm is injection molded so as to form the servo surface shown in FIGS. 6 and 7. The width of the tracking groove 110 is varied between 500 nm and 1500 nm. The track pitch is made a constant value of 10 μm. A Kr⁺ laser having a wavelength of 413 nm is used for mastering, and focal position control and mastering power control are performed to control the width of the groove. An address signal and a recording start position control signal are formed as a pre-pit train in the header section.

Next, an Ag alloy film having a thickness of 150 nm is formed as the reflecting layer 12 on the servo surface by sputtering, and then the Ag alloy film is coated with UV resin, which is cured and molded, so as not to be damaged. Then, a SiO₂ film as the intermediate layer 13 having a thickness of 50 nm is formed on the incidence surface (the surface opposite to the servo surface) of the substrate 11 by sputtering. On this intermediate layer 13 a hologram recording layer 14 is formed by casting as follows. At first, raw materials of a photopolymer, an initiator, and a matrix, which are all liquid, are mixed well, and then a predetermined amount of the mixture is poured into a Teflon(R) mold which has a diameter identical to that of the substrate and is provided with thin Teflon rings, having a thickness of 200 μm, at the inner periphery and the outer periphery thereof. A Teflon plate is pressed over the mold, and fixed to the mold with a jig. After vacuum defoaming, the mold is left standing for 12 hours at 60° C. to cure the matrix for the hologram recording layer. The reason why the Teflon mold is used is to facilitate the cured hologram recording layer to be released from the mold. The Teflon plate on the mold is removed, and then a thermosetting transparent adhesive layer is spin-coated on the SiO₂ intermediate layer 13. After that, the cured hologram recording layer is placed on the adhesive layer together with the mold, a vacuum defoaming process is slightly performed on it, and it is left standing for 12 hours at 60° C. for curing. Next, the Teflon rings and the mold are removed, and then a SiO₂ film as the protection layer 15 having a thickness of 100 nm is formed on the hologram recording layer 14 by sputtering. Thus, the hologram recording medium shown in FIG. 4 is obtained. The sensitivities of the photopolymer and initiator contributing to recording are adjusted so as to be large at 405 nm and almost zero at 650 nm or more.

Next, the resultant hologram recording medium is set in a laboratory recording/reproducing device shown in FIG. 3. A laser diode with an external resonator having a wavelength of 405 nm is used as the recording/reproducing light source 31, and a laser diode having a wavelength of 780 nm is used as the servo light source 51.

At first, the hologram recording medium 10 is set on the spindle motor (not shown in FIG. 3), and is rotated at a linear velocity of 1 m/s. Next, the servo light source is turned on, and focusing servo and tracking servo are performed. Since the hologram recording medium 10 in this example has the servo surface shown in FIGS. 6 and 7, tracking servo can be achieved when the groove width is set at a value between 500 nm and 1150 nm. However, off-tracking occurs frequently when the groove width is set at 1150 nm or more. Consequently, it is found that it is desirable to set the width of the tracking groove 110 is set at a value equal to or less than 80% of the e⁻² of the servo beam in order to obtain a good tracking characteristic.

Hologram recording mediums capable of attaining tracking are used for write experiments. A write beam and a reference beam are applied to the read-in area on the innermost periphery of the disk, and the λ/2 plate 33 is rotated, while monitoring the outputs of the write beam PD 36 and reference beam PD 38, such that the intensities of the write beam and reference beam applied to the medium 10 substantially match with each other. Next, the shutter 21 shown in FIGS. 1 and 2 (to be disposed between the PBS 34 on the light source side and the SLM 22 in FIG. 3, but not shown in FIG. 3) is closed, and the servo beam is applied to the data sections for tracking. Write operation is performed with opening the shutter every time the servo beam moved the distance of 10 μm on the medium.

Next, reproducing operation is performed. At first, only the servo light source 51 is turned on to apply a servo beam to the medium, and the address information on the header sections is read to detect a recorded sector. Next, the recording/reproducing light source 31 is turned on and the reference beam is continuously applied to the data sections with the shutter on the path of the write beam kept closed. Since an interference pattern has not been formed on non-recording positions, there is no diffracted light, and the reference beam reflected by the servo surface 11s passes through the gyrator 24. The reference beam is then changed to s-polarized light. The s-polarized light is turned 90° by the PBS 23, and is made incident on the first HM 35. In recorded positions, the reference beam is diffracted by the recorded interference pattern. This diffracted light is returned to p-polarized light by the gyrator 24. The p-polarized light passes through the PBS 23 and the second HM 37, and then is made incident on the CCD 40, where it is converted to an electric signal. By comparing the pattern detected by the CCD 40 with the pattern on the SLM 22 in recording, it can be determined whether the recording is performed well.

In this example, it is found that when the width of the tracking groove is less than 750 nm the difference between both patterns is large and recording has not been well performed. Consequently, it is found that the width of the tracking groove on the servo surface should be set at a value larger than the e⁻² diameter of the write/reference beam.

In the case where the width of the tracking groove is 750 nm, the error rate is about 10 E-4, which is barely practical. On the other hand, in the case where the width of the tracking groove is 890 nm or more, the error rate is 10 E-5 or less, and in case where the width of the tracking groove is 1120 nm or more, the error rate is about 10 E-6. From these results, it is found that the groove width is preferably set at a value equal to or more than 1.2 times, more preferably equal to or more than 1.5 times of the e⁻² diameter of the write/reference beam.

Furthermore, in the medium of this example, even when the length of the data section is increased as far as possible, recording and reproducing can be performed. For example, it is found that when the length of the data section is set at about 3 mm, the format efficiency can be a high value equal to or more than 75% like current DVDs. Seek operations are tried 10 E4 times, and light beam can be allowed to seek predetermined tracks without an error. When recording/reproducing operations are tried for DVDs by using a laser having a wavelength of 650 nm (not shown in FIG. 3) in the same recording/reproducing system, both of recordable DVDs and read-only DVDs are operated without any problem. Incidentally, for practical use, it is of course necessary to add a part of an optical system similar to that for a current DVD in addition to the configuration in FIG. 3. When current CDs are operated using the servo beam, both of recordable CDs and read-only CDs can be operated without any problem.

### Comparative Example

As a comparable example, a substrate having a conventional sample servo pattern as shown in FIG. 5 is mastered to form a medium, to which experiments are performed as described above. For the conventional medium, the data section of which is a mirror surface, in the case where the length of the data section is as short as 0.3 mm or less, tracking and recording/reproducing operations can be performed without any problem with an error rate of about 10 E-6. However, in the case where the length of the data section is set at a value equal to or more than 0.5 mm, off-tracking occurs frequently and significant recording/reproducing operations become difficult. Incidentally, when the length of the data section is 0.3 mm, the format efficiency is restricted to a low value less than 40%.

Seek operations are tried 10 E4 times for the conventional medium. As a result, even when the length of the data section is 0.3 mm, several track count errors occur, and when the length of the data section is 0.5 mm or more, track count errors more than ten times occur, and consequently it is found that it is difficult to make the beam seek to predetermined tracks rapidly.

It is assumed that the reason why recording/reproducing can also be performed for a hologram medium having a conventional sample servo pattern when a tracking servo detecting system suitable for continuous servo in FIG. 3 is used is that the track pitch is as wide as bout 10 μm in the hologram recording. It is assumed that when a tracking servo detection system suitable for sample servo is used, it is possible to increase the data length also in a conventional hologram medium of a sample servo-type. However, a tracking servo detecting system suitable for continuous servo has a configuration different from that of a tracking servo detecting system suitable for sample servo. For this reason, in order to provide compatibility between a hologram recording medium which uses conventional sample servo and has a large length of the data section and current DVDs or CDs (having continuous grooves whose track pitch is the order of sub microns to microns for a recordable type, and having a continuous pit train for a read-only type), both of a tracking servo detecting system suitable for continuous servo and a tracking servo detecting system suitable for sample servo are required, thereby complicating the configurations of the optical system, electronic system and control system, leading to increase of cost.

### Example 2

In this example, the hologram recording medium according to the embodiment [2] will be explained.

The hologram recording medium having a stacked structure shown in FIG. 4 is manufactured as follows. A polycarbonate disk substrate 11 having a diameter of 120 mm and a thickness of 0.6 mm is injection molded so as to form the servo surface shown in FIG. 8. Taking the result of the example 1 into consideration, the width of the tracking groove 110 in the positions other than the write positions is set at 490 nm equal to 66% of the e⁻² diameter of the reference beam (serves as a servo beam in this example) which provide the most stable tracking. As shown in FIG. 8, the write positions R are provided with the interval of 10 μm corresponding to an appropriate shift amount. Also, taking the result of the example 1 into consideration, the diameter of the write positions R is set at 1200 nm so as to be rarely influenced by irregular reflection of the write/reference beam. The track pith is made a constant value of 10 μm. A Kr⁺ laser having a wavelength of 413 nm is used for mastering, and focal position control and mastering power control are performed to control the shape of the groove pattern in the write positions and the non-recording positions other than the write positions. An address signal and a recording start position control signal are formed as a pre-pit train in the header section.

Next, an Ag alloy film having a thickness of 120 nm is formed as the reflecting layer 12 on the servo surface by sputtering, and then the Ag alloy film is coated with UV resin, which is cured and molded, so as not to be damaged. Then, an AlN film as the intermediate layer 13 having a thickness of 10 nm is formed on the incidence surface (the surface opposite to the servo surface) of the substrate 11 by sputtering. On this intermediate layer 13 a hologram recording layer 14 is formed by casting as follows. At first, raw materials of a photopolymer, an initiator, and a matrix, which are all liquid, are mixed well, and then a predetermined amount of the mixture is poured into a Teflon mold which has a diameter identical to that of the substrate and is provided with thin Teflon rings, having a thickness of 200 μm, at the inner periphery and the outer periphery thereof. A Teflon plate is pressed over the mold, and fixed to the mold with a jig. After vacuum defoaming, the mold is left standing for 12 hours at 60° C. to cure the matrix for the hologram recording layer. The reason why the Teflon mold is used is to facilitate the cured hologram recording layer to be released from the mold. The Teflon plate on the mold is removed, and then a thermosetting transparent adhesive layer is spin-coated on the AlN intermediate layer 13. After that, the cured hologram recording layer is placed on the adhesive layer together with the mold, a vacuum defoaming process is slightly performed on it, and it is left standing for 12 hours at 60° C. for curing. Next, the Teflon rings and the mold are removed, and then a SiO₂ film as the protection layer 15 having a thickness of 100 nm is formed on the hologram recording layer 14 by sputtering. Thus, the hologram recording medium shown in FIG. 4 is obtained. The sensitivities of the photopolymer and initiator contributing to recording are adjusted so as to be large at 405 nm and almost zero at 650 nm or more.

Next, the resultant hologram recording medium is set in a laboratory recording/reproducing device similar to that shown in FIG. 3. A laser diode with an external resonator having a wavelength of 405 nm is used as the recording/reproducing light source 31. In this example, since the recording/reproducing light source 31 is also used as a servo light source, the servo light source is omitted.

At first, the hologram recording medium 10 is set on the spindle motor (not shown in FIG. 3), and is rotated at a linear velocity of 1 m/s. Next, the recording/reproducing light source 31 is turned on, the shutter of the write beam incident system is closed, and focusing servo and tracking servo are performed using the reference beam. Since the hologram recording medium in this example has the servo surface shown in FIG. 8, good tracking can be achieved. That is, the reference beam reflected on the non-recorded sections is turned to the right side of the PBS 23 in FIG. 3, passes through the first HM 35 and is made incident on the servo detecting system 42. For this reason, the reference beam can be used for servo detection in an optical system equivalent to that of FIG. 3.

Next, write operation is tried. A write beam and a reference beam are applied to the read-in area on the innermost periphery of the disk, and the λ/2 plate 33 is rotated, while monitoring the outputs of the write beam PD 36 and reference beam PD 38, such that the intensities of the write beam and reference beam applied to the medium 10 substantially match with each other. Next, the shutter 21 shown in FIGS. 1 and 2 (to be disposed between the PBS 34 on the light source side and the SLM 22 in FIG. 3, but not shown in FIG. 3) is closed, and the reference beam is applied to the data sections for tracking. Write operation is performed with the shutter opened at a time when the tracking signal becomes extinct, that is, at the instant when the reference beam reaches a write position in FIG. 8. While the beam is passing through the write position R in FIG. 8, tracking operation by the reference beam is not performed. However, this is not a problem at all for achieving tracking because the length of the recording position R is about 1.2 μm at most. This is reasonable judging from the result that relatively stable tracking can be achieved in the case of sample servo for the conventional example with the data section having a length of 0.3 mm or less, which is a traveling distance under tracking free operation, as described above.

Next, reproducing operation is performed. At first, the reference beam is applied to the medium to read the address information recorded on the header sections of the sectors, and then the reference beam is continuously applied to the medium with the shutter held closed. Since an interference pattern has not been formed on the non-recording positions, there is no diffracted light, and the reference beam reflected by the servo surface 11s passes through the gyrator 24. The reference beam is then changed to s-polarized light. The s-polarized light is turned 90° by the PBS 23. The turned s-polarized light is made incident on the first HM 35, and then is made incident on the servo detecting system 42. Thus, only the servo signal is obtained from the non-recording positions, and information light is not made incident on the CCD 40. In recorded position, the reference beam is diffracted by the recorded interference pattern. This diffracted light is returned to p-polarized light by the gyrator 24. The p-polarized light passes through the PBS 23 and the second HM 37, and then is made incident on the CCD 40, where it is converted to an electric signal. By comparing the pattern detected by the CCD 40 with the pattern on the SLM 22 in recording, it can be determined whether the recording is performed well. In this case, the error rate is about 10 E-6, and it is found that both of formation of an excellent interference pattern and stable tracking are well combined.

Furthermore, in the medium of this example, even when the length of the data section is increased as far as possible, recording and reproducing can be performed. It is found that the format efficiency can be a high value equal to or more than 75% like current DVDs.

Seek operations are tried 10 E4 times, and light beam can be allowed to seek predetermined tracks without an error.

When recording/reproducing operations are tried for DVDs by using a laser having a wavelength of 650 nm (not shown in FIG. 3) in the same recording/reproducing system, both of recordable DVDs and read-only DVDs are operated without any problem. Incidentally, for practical use, it is of course necessary to add a part of an optical system similar to that for a current DVD in addition to the configuration in FIG. 3. When current CDs are operated using the servo beam, both of recordable CDs and read-only CDs can be operated without any problem.

### Example 3

In this example, the hologram recording medium according to the embodiment [4] will be explained.

The hologram recording medium having a stacked structure shown in FIG. 4 is manufactured as follows. A polycarbonate disk substrate 11 having a diameter of 120 mm and a thickness of 0.6 mm is injection molded so as to form the servo surface shown in FIG. 10. Taking the result of the example 1 into consideration, the width of the tracking groove 130 is set at a value between 20% and 80% of the e⁻² diameter of the reference beam (serves as a servo beam in this example) which provide the most steady tracking. That is, the width of the tracking groove is set at a value between about 150 nm and 600 nm for λ of 405 nm and NA of 0.45. However, the basic concept of this example is that the depth of the tracking groove is set at an extinction condition and an interference pattern is recorded using reflected light from the mirror surfaces on both sides of the groove. Therefore, if the width of the groove is too large, area of the mirror surfaces become too small, and consequently it becomes difficult to record a predetermined interference pattern. As described above, the servo surface is manufactured with varying the groove width between 150 nm and 600 nm in order to find the upper limit of the groove width. The track pith is set at 10 μm corresponding to the shift amount. The depth of the groove is set at λ/4n so as to be an extinction condition. Here, n is the refractive index of the substrate, and is about 1.5 for the polycarbonate substrate. In this example, the depth of the groove is set at about 68 nm. The recording positions in the track direction (tangential direction) are provided with a pitch of about 10 μm. A Kr⁺ laser having a wavelength of 413 nm is used for mastering, and focal position control and mastering power control are performed to control the shape of the pre-pit pattern and the groove pattern in the data section. An address signal and a recording start position control signal are formed as a pre-pit train in the header section.

Next, Ag alloy film having a thickness of 100 nm is formed as the reflecting layer 12 on the servo surface by sputtering, and then the Ag alloy film is coated with UV resin, which is cured and molded, so as not to be damaged. Then, a ZnS—SiO₂ (1:1) film as the intermediate layer 13 having a thickness of 30 nm is formed on the incidence surface (the surface opposite to the servo surface) of the substrate 11 by sputtering. On this intermediate layer 13 a hologram recording layer 14 is formed by casting as follows. At first, raw materials of a photopolymer, an initiator, and a matrix, which are all liquid, are mixed well, and then a predetermined amount of the mixture is poured into a Teflon mold which has a diameter identical to that of the substrate and is provided with thin Teflon rings, having a thickness of 200 μm, at the inner periphery and the outer periphery thereof. A Teflon plate is pressed over the mold, and fixed to the mold with a jig. After vacuum defoaming, the mold is left standing for 12 hours at 60° C. to cure the matrix for the hologram recording layer. The reason why the Teflon mold is used is to facilitate the cured hologram recording layer to be released from the mold. The Teflon plate on the mold is removed, and then a thermosetting transparent adhesive layer is spin-coated on the ZnS—SiO₂ intermediate layer 13. After that, the cured hologram recording layer is placed on the adhesive layer together with the mold, a vacuum defoaming process is slightly performed on it, and it is left standing for 12 hours at 60° C. for curing. Next, the Teflon rings and the mold are removed, and then a SiO₂ film as the protection layer 15 having a thickness of 200 nm is formed on the hologram recording layer 14 by sputtering. Thus, the hologram recording medium shown in FIG. 4 is obtained. The sensitivities of the photopolymer and initiator contributing to recording are adjusted so as to be large at 405 nm and almost zero at 650 nm or more.

Next, the resultant hologram recording medium is set in a laboratory recording/reproducing device similar to that shown in FIG. 3. A laser diode with an external resonator having a wavelength of 405 nm is used as the recording/reproducing light source 31. In this example, since the recording/reproducing light source 31 is also used as a servo light source, the servo light source is omitted.

At first, the hologram recording medium 10 is set on the spindle motor (not shown in FIG. 3), and is rotated at a linear velocity of 1 m/s. Next, the recording/reproducing light source 31 is turned on, the shutter of the write beam incident system is closed, and focusing servo and tracking servo are performed using the reference beam. Since the hologram recording medium in this example has the servo surface shown in FIG. 10, good tracking can be achieved for the groove width ranging from 150 nm to 600 nm. Also in this example, the reference beam reflected on the non-recorded sections is turned to the right side of the PBS 23 in FIG. 3, passes through the first HM 35 and is made incident on the servo detecting system 42. For this reason, the reference beam can be used for servo detection in an optical system equivalent to that of FIG. 3.

Next, write operation is tried. A write beam and a reference beam are applied to the read-in area on the innermost periphery of the disk, and the λ/2 plate 33 is rotated, while monitoring the outputs of the write beam PD 36 and reference beam PD 38, such that the intensities of the write beam and reference beam applied to the medium 10 substantially match with each other. Next, the shutter 21 shown in FIGS. 1 and 2 (to be disposed between the PBS 34 on the light source side and the SLM 22 in FIG. 3, but not shown in FIG. 3) is closed, and the reference beam is applied to the data sections for tracking. Write operation is performed with the shutter opened at the instant when the reference beam reaches the write position (not shown particularly in FIG. 10) which is set in such a manner that the reference beam provides sift multiplexing recording at a 10 μm pitch.

Next, reproducing operation is performed. At first, the reference beam is applied to the medium to read the address information recorded on the header sections of the sectors, and then the reference beam is continuously applied to the medium with the shutter held closed. Since an interference pattern has not been formed on the non-recording positions, there is no diffracted light, and the reference beam reflected by the servo surface 11s passes through the gyrator 24. The reference beam is then changed to s-polarized light. The s-polarized light is turned 90° by the PBS 23. The turned s-polarized light is made incident on the first HM 35, and then is made incident on the servo detecting system 42. Thus, only the servo signal is obtained from the non-recording positions, and information light is not made incident on the CCD 40. In recorded position, the reference beam is diffracted by the recorded interference pattern. This diffracted light is returned to p-polarized light by the gyrator 24. The p-polarized light passes through the PBS 23 and the second HM 37, and then is made incident on the CCD 40, where it is converted to an electric signal. By comparing the pattern detected by the CCD 40 with the pattern on the SLM 22 in recording, it can be determined whether the recording is performed well.

In this example, the error rate is about 10 E-5 for the groove width of 150 nm. However, the error rate increases gradually as the groove width increases, and the error rate becomes 10 E-4 for the groove width of 300 nm, which barely satisfied the system requirement. For a groove width more than 300 nm, it is difficult to obtain a practical error rate. Consequently, in this example according to the fourth embodiment, it is found that it is desirable to set the groove width at a value between 20% (lower limit to obtain good tracking) and 40% (upper limit allowing a good interference pattern) of the e⁻² diameter on the focal position of the write beam and reference beam. When the groove width is in this range, both of formation of an excellent interference pattern and stable tracking can be well combined.

Furthermore, in the medium of this example, even when the length of the data section is increased as far as possible, recording and reproducing can be performed. It is found that the format efficiency can be a high value equal to or more than 75% like current DVDs.

Seek operations are tried 10 E4 times, and light beam can be allowed to seek predetermined tracks without an error.

When recording/reproducing operations are tried for DVDs by using a laser having a wavelength of 650 nm (not shown in FIG. 3) in the same recording/reproducing system, both of recordable DVDs and read-only DVDs are operated without any problem. Incidentally, for practical use, it is of course necessary to add a part of an optical system similar to that for a current DVD in addition to the configuration in FIG. 3. When current CDs are operated using the servo beam, both of recordable CDs and read-only CDs can be operated without any problem.

### Example of System Configuration

In the above examples, configurations of hologram mediums, in particular, configurations of servo surfaces and configuration of pickups are explained. In the following description, an example of a system configuration applicable to all of the examples is briefly explained.

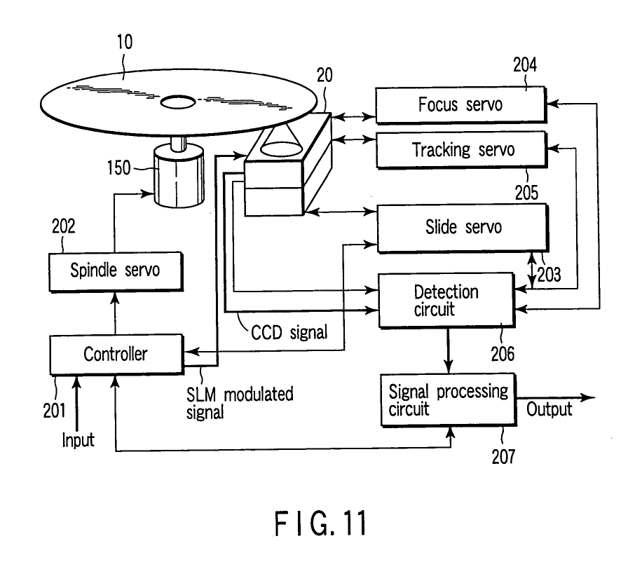

FIG. 11 is a schematic view showing a system configuration of a hologram recording/reproducing device according to the embodiments of the present invention. The disk-shaped hologram recording medium 10 is attached to and rotated by the spindle motor 10. Recording and reproduction are performed by applying a write beam and a reference beam to the hologram recording medium 10 from the optical system as shown in FIG. 3, for example. These components are controlled by means of the controller 201. The controller is connected to PC or AV equipment through interfaces. An output control signals are output from the controller 201 to each of the equipment according to input signals from the interfaces. One of the output control signals output from the controller 201 is input to the driving circuit (spindle servo) 202 for the spindle motor 150 to control the number of revolutions of the motor. Another of the output control signals from the controller 201 is a write signal output for driving the SLM included in the optical system 20. The output control signals from the controller 201 further include mechanical control signals for a slide servo 203 (shift amount control, write position control), a focus servo 204 and a tracking servo 205 and the like. All of these mechanical control signals are used for performing feedback controls based on photo-detection signals. Photo-detection signals in the optical system 20 include a write beam (information light) intensity signal, a reference beam intensity signal, a focusing and tracking detection light intensity signal, a header section reproducing signal (this is for write position control for examples 1 and 3, and the header section in the example 2 may not have a write position signal), and the like. These photo-detection signals are electrically processed by the detection circuit 206 and then returned to the controller 201 to perform predetermined focusing, tracking, and positioning for write with stability. As the reproducing device, a CCD is typically used as explained in the examples 1 to 3, and other image sensor array may be used. A reproducing signal is electrically processed by the detection circuit 206, and then converted (e.g., parallel-serial conversion or the like) to data series by the signal processing circuit 207. The output of the signal processing circuit 207 is basically returned to the controller 201 and then output to the PC or AV equipment through the interfaces. However, it is possible to transmit images to display equipment directly without through the controller 201.

### Modified Example

The wavelength of the write/reference beam is set at 405 nm in the above examples 1 to 3, the wavelength of the servo beam is set at 780 nm in the example 1 (the reference beam having the wavelength of 405 nm is also used as a servo beam in the examples 2 and 3), and the NA of the objective lens is set at 0.45. However, it should be understood that the wavelength and NA are not particularly limited within the scope of the purpose of the invention.

For example, in the example 1, it is desired to be able to select the range of the spot size (e⁻² diameter) of the write or reference beam smaller than the range of 20% to 80% of the spot size (e⁻² diameter) of the servo beam in which tracking servo can be achieved with stability. In general, an e⁻² diameter of a light beam is given by 0.83×(λ/NA), where λ is a wavelength and NA is a numerical aperture. Hence, in case of the example 1, λ and NA can be freely selected in the range of the above common set.

In the examples 2 and 3, tracking servo is performed with a reference beam, and a servo beam having a different wavelength may be added. However, servo is preferably performed with a reference beam in order to simplify an optical system. It should be understood that also in the case where the servo is performed with a reference beam, the wavelength of the write beam or reference beam is not limited to 405 nm, and may be selected freely. In the example 2, the width of the groove and the sizes of the write positions may be changed according to the wavelength. In the example 3, the width of the groove may be changed according to the wavelength.

Furthermore, the shapes of the write positions in the example 2 may be made longer in the tangential direction according to the sensitivity of the recording layer. In the case where the sensitivity is high, the shapes of the write positions may be perfect circles, but in the case where the sensitivity is low, the shapes of the write positions are preferably made longer in the tangential direction to make the write time longer.

(Light Source)

Finally, the light source will be explained including prospects in the future. For hologram recording, a laser having a large coherence length is absolutely necessary. In the above description, a laser with an external resonator having a wavelength of 405 nm is used as the recording/reproducing light source, but such a laser is expensive at present. However, it is expected that a low price laser having a large coherence length will be realized in the future. Actually, a distributed feedback (DFB) laser having a wavelength range in the near infrared is developed, which is mainly used for a communication purpose. A DFB laser having a short wavelength has not been developed, but it is expected that it will be developed in the future. A DFB laser may be produced by patterning a diffract grating between the active layer and a clad layer, by which only one etching process is added to an ordinal producing process, and thereby a DFB laser possibly becomes a low price laser. In addition to the DFB laser, a distributed Bragg reflector (DBR) laser, and a vertical cavity surface-emitting laser (VCSEL) are also promising as hologram recording light sources in the future.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A hologram recording medium comprising:
a transparent substrate having an incidence surface, on which a servo beam, a write beam and a reference beam are made incident, and a servo surface opposite to the incidence surface, the servo surface including a header section and a data section;
a reflecting layer formed on the servo surface of the transparent substrate; and
a hologram recording layer provided on the incidence surface of the transparent substrate,
the servo surface having a continuous tracking groove in the data section, and a width of the tracking groove being set at a value less than an e⁻² diameter of the servo beam and at a value equal to or more than an e⁻² diameter of the write beam and reference beam.

2. A hologram recording medium comprising:
a transparent substrate having an incidence surface, on which a write beam and a reference beam are made incident, and a servo surface opposite to the incidence surface, the servo surface including a header section and a data section;
a reflecting layer formed on the servo surface of the transparent substrate; and
a hologram recording layer provided on the incidence surface of the transparent substrate,
the servo surface having a continuous tracking groove in the data section, and a width of the tracking groove being set at a value equal to or more than an e⁻² diameter of the write beam and reference beam at recording positions and less than an e⁻² diameter of the reference beam at non-recording positions.

3. A hologram recording medium comprising:
a transparent substrate having an incidence surface, on which a write beam and a reference beam are made incident, and a servo surface opposite to the incidence surface, the servo surface including a header section and a data section;
a reflecting layer formed on the servo surface of the transparent substrate; and
a hologram recording layer provided on the incidence surface of the transparent substrate,
the servo surface having intermittent tracking grooves in the data section except for recording positions, and a width of the tracking grooves being set at a value less than an e⁻² diameter of the reference beam.

4. A hologram recording medium comprising:
a transparent substrate having an incidence surface, on which a write beam and a reference beam are made incident, and a servo surface opposite to the incidence surface, the servo surface including a header section and a data section;
a reflecting layer formed on the servo surface of the transparent substrate; and
a hologram recording layer provided on the incidence surface of the transparent substrate,
the servo surface having a continuous tracking groove in the data section, a depth of the tracking groove being set at an extinction condition, and a width of the tracking groove being set at a value between 20% and 40% of an e⁻² diameter of the write beam and reference beam.

5. A method of hologram recording and reproduction for a hologram recording medium comprising a transparent substrate having an incidence surface, on which a servo beam, a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having a continuous tracking groove in the data section, and a width of the tracking groove being set at a value less than an e⁻² diameter of the servo beam and at a value equal to or more than an e⁻² diameter of the write beam and reference beam,
the method comprising:
performing tracking servo by applying the servo beam to the servo surface while adjusting the focal position to the servo surface and by utilizing the reflected servo beam;
performing recording to the hologram recording layer by applying simultaneously both of the write beam carrying data to be recorded and reference beam, whose polarization planes are matched with each other, to the recording positions while adjusting the focal positions to the servo surface; and
performing reproduction from the hologram recording layer by applying the reference beam to the recording positions while adjusting the focal position to the servo surface.

6. A method of hologram recording and reproduction for a hologram recording medium comprising a transparent substrate having an incidence surface, on which a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having a continuous tracking groove in the data section, and a width of the tracking groove being set at a value equal to or more than an e⁻² diameter of the write beam and reference beam at recording positions and less than an e⁻² diameter of the reference beam at non-recording positions,
the method comprising:
performing tracking servo by applying the reference beam while adjusting the focal position to the servo surface and by utilizing the reflected reference beam;
performing recording to the hologram recording layer by applying simultaneously both of the write beam carrying data to be recorded and reference beam, whose polarization planes are matched with each other, to the recording positions while adjusting the focal positions to the servo surface; and
performing reproduction from the hologram recording layer by applying the reference beam to the recording positions while adjusting the focal position to the servo surface.

7. A method of hologram recording and reproduction for a hologram recording medium comprising a transparent substrate having an incidence surface, on which a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having intermittent tracking grooves in the data section except for recording positions, and a width of the tracking grooves being set at a value less than an e⁻² diameter of the reference beam,
the method comprising:
performing tracking servo by applying the reference beam while adjusting the focal position to the servo surface and by utilizing the reflected reference beam;
performing recording to the hologram recording layer by applying simultaneously both of the write beam carrying data to be recorded and reference beam, whose polarization planes are matched with each other, to the recording positions while adjusting the focal positions to the servo surface; and
performing reproduction from the hologram recording layer by applying the reference beam to the recording positions while adjusting the focal position to the servo surface.

8. A method of hologram recording and reproduction for a hologram recording medium comprising a transparent substrate having an incidence surface, on which a write beam and a reference beam are made incident, and a servo surface opposite to the incidence surface, the servo surface including a header section and a data section; a reflecting layer formed on the servo surface of the transparent substrate; and a hologram recording layer provided on the incidence surface of the transparent substrate, the servo surface having a continuous tracking groove in the data section, a depth of the tracking groove being set at an extinction condition, and a width of the tracking groove being set at a value between 20% and 40% of an e⁻² diameter of the write beam and reference beam, the method comprising:
performing tracking servo by applying the reference beam while adjusting the focal position to the servo surface and by utilizing the reflected reference beam;
performing recording to the hologram recording layer by applying simultaneously both of the write beam carrying data to be recorded and reference beam, whose polarization planes are matched with each other, to the recording positions while adjusting the focal positions to the servo surface; and
performing reproduction from the hologram recording layer by applying the reference beam to the recording positions while adjusting the focal position to the servo surface.
